(19) United States
(12) Patent Application Publication
(10) Pub. No.: US 2014/0359711 A1
(43) Pub. Date: Dec. 4, 2014

(54) DIGITAL DATA PROCESSING SYSTEM AND METHOD

(71) Applicant: HON HAI PRECISION INDUSTRY CO., LTD., New Taipei (TW)

(72) Inventors: EN-SHIH LIN, New Taipei (TW); JEN-HUNG LO, New Taipei (TW); PANG-HAO LIU, New Taipei (TW); SHIH-YING CHEN, New Taipei (TW); MENG-LUNG SHEN, New Taipei (TW); CHUNG-YING YU, New Taipei (TW)

(73) Assignee: HON HAI PRECISION INDUSTRY CO., LTD., New Taipei (TW)

(21) Appl. No.: 14/139,909

(22) Filed: Dec. 24, 2013

(30) Foreign Application Priority Data
May 31, 2013 (TW) 102119273

(51) Int. Cl. H04L 29/06

(52) U.S. Cl. CPC H04L 63/108
USPC 726/4

(57) ABSTRACT

A digital data processing method obtains an authorization level of a connected client device. The method further searches for available digital data to be browsed corresponding to the obtained authorization level and transmits parameters of the available digital data to the connected client device. The method further determines whether the connected client device has authorization to process specified digital data selected from the available digital data when a processing command is received. If the connected client device has authorization to process the specified digital data, the method transmits the specified digital data to the connected client device.

### BACKGROUND

1. Technical Field

Embodiments of the present disclosure relate to digital data, and more particularly to digital data processing system and a method for processing digital data thereof.

2. Description of Related Art

Many teachers use computers to teach and communicate with students in a class and outside the class. If digital data (e.g. electronic files of textbooks or outside readings) is stored in the computer, the teachers can interact with the students conveniently and the students can study anytime and anywhere. However, the digital data cannot be easily processed by the students, and the students cannot provide the digital data conveniently to communicate or interact with the teacher.

### BRIEF DESCRIPTION OF THE DRAWINGS

FIG. 1 is a block diagram of one embodiment of a first server including a digital data processing system.

FIG. 2 is a block diagram of one embodiment of function modules of the digital data processing system in FIG. 1.

FIG. 3 is a flowchart of one embodiment of a digital data processing method.

FIG. 4 is a flowchart of one embodiment of a digital data uploading method.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

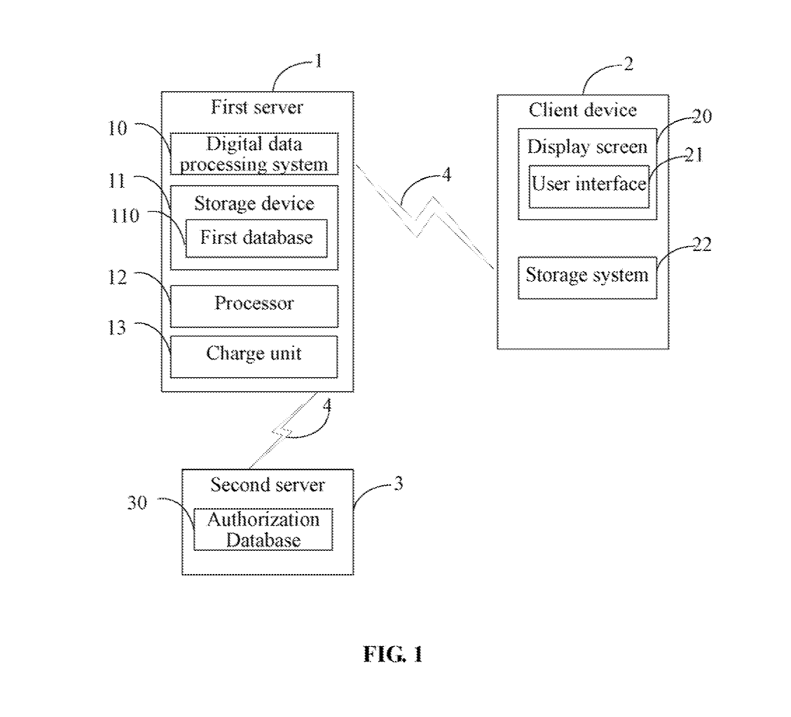

FIG. 1 is a block diagram of one embodiment of a first server 1 including a digital data processing system 10. The first server 1 is connected to one or more client devices 2 (only one shown in FIG. 1) and a second server 3 through a network 4 (e.g. the Internet or an intranet). The first server 1 includes a non-transitory storage device 11, at least one processor 12 and a charge unit 13. The storage device 11 is a dedicated memory, such as an EPROM, a hard disk driver (HDD), or flash memory. The processor 12 executes one or more computerized codes and other applications for the first server 1, to provide the functions of the digital data processing system 10.

In one embodiment, the storage device 11 includes a first database 110 storing digital data and parameters of the digital data. The digital data corresponds to one or more authorization levels which are available to be browsed. The parameters of each of the digital data include, but are not limited to, a name, a minimizing chart, a price, and a brief, for example. The first database 110 further includes registration information of each of the client devices 2. The registration information includes, but is not limited to, an account name, a password, and an authorization level of each of the client devices 2.

The charge unit 13 is a payment platform between the first server 1 and the client devices 2. The client devices 2 can pay money for the digital data to the first server 1 using the charge unit 13. If the payment is completed by the client devices 2, the charge unit 13 transmits a prompt of a successful trade to the first server 1.

Each of the client devices 2 includes a display screen 20 and a storage system 22. Each of the client devices 2 displays a user interface 21 provided by the first server 1, on the display screen 20. The user interface 21 includes a browsing interface and an editing interface. The client devices 2 is connected to the first server 1 to browse available digital data through the browsing interface, and to process digital data or to upload digital data through the editing interface. The storage system 22 stores data of each of the client devices 2, such as, downloaded digital data.

The second server 3 includes an authorization database 30 storing data of different authorization levels corresponding to account numbers of different client devices 2, and storing data of available operations on the digital data corresponding to each of the authorization levels. The available operations may include a downloading operation, a purchasing operation, and a uploading operation, for example. In other embodiments, the authorization database 30 may be included in the first server 1.

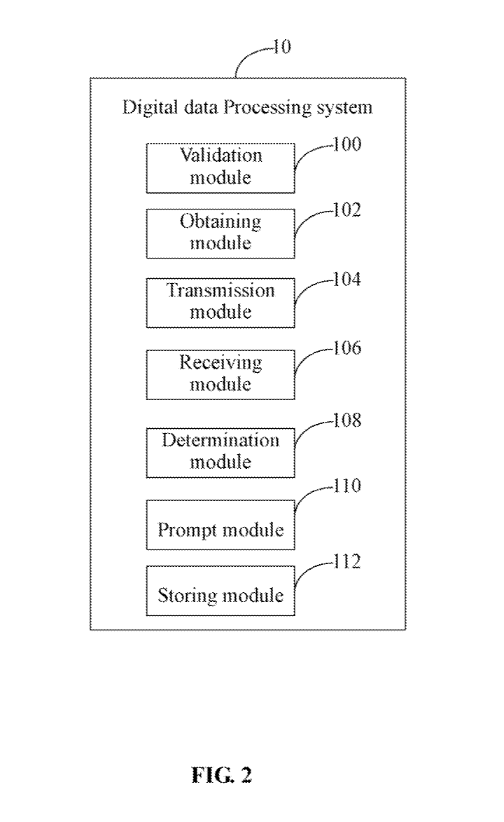

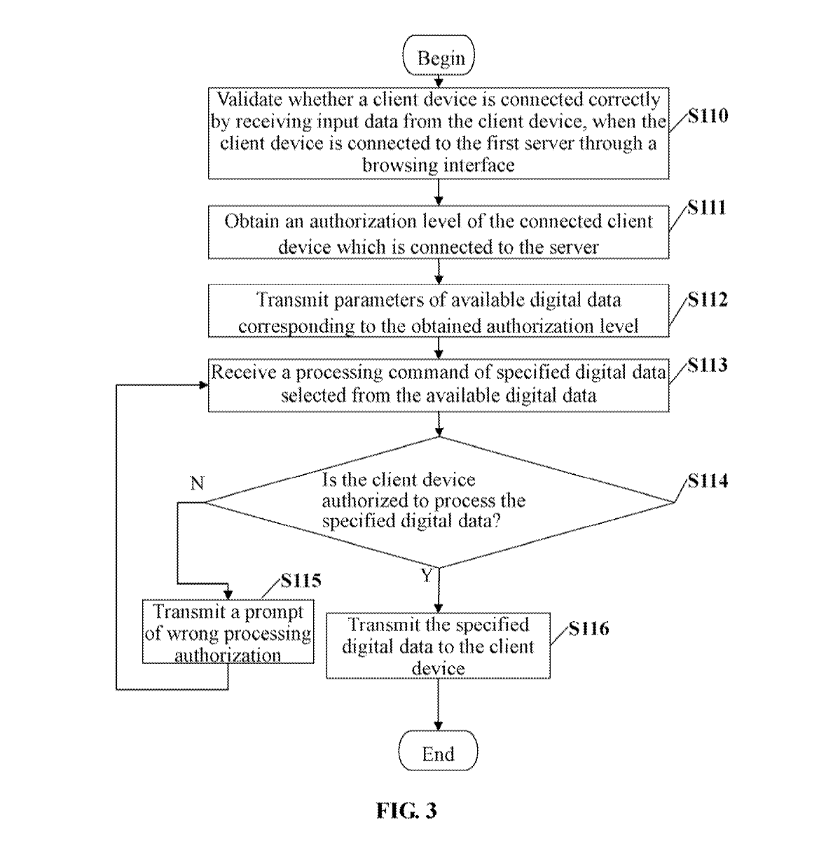

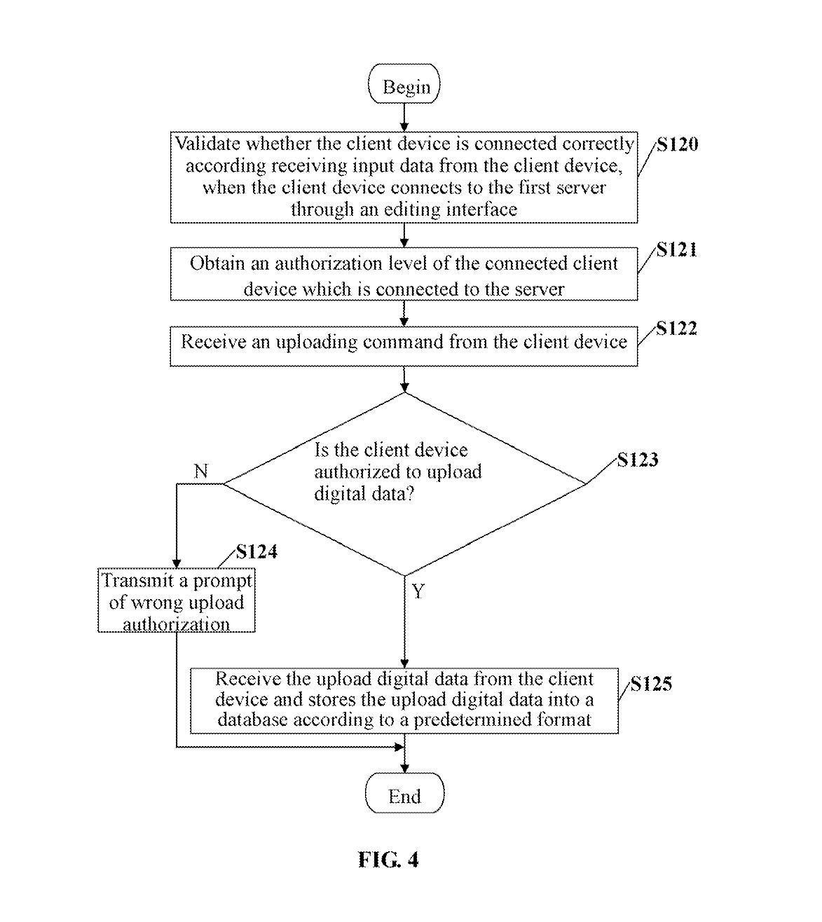

As shown in FIG. 2, the digital data processing system 10 includes a plurality of function modules, such as a validation module 100, an obtaining module 102, a transmission module 104, a receiving module 106, a determination module 108, a prompt module 110 and a storing module 112. The modules 100, 102, 104, 106, 108, 110, and 112 include computerized code in the form of one or more programs that are stored in the storage device 11 of the first server 1. The computerized code includes instructions that are executed by the at least one processor 12 of the first server 1 to provide functions of the digital data processing system 10. Detailed descriptions of the functions of the modules are given below with reference to FIG. 3-FIG. 4.

FIG. 3 is a flowchart of one embodiment of a digital data processing method. Depending on the embodiment, additional steps may be added, others removed, and the ordering of the steps may be changed.

In step S110, the validation module 100 validates whether the client device 2 is connected correctly using a password and account name. The validation module 100 compares the account name and the password received from the client device 2 with the registration information stored in the content database 110. If an account name in the registration information is the same as the received account name, and the received password matches a password corresponding to the account name, the validation module 100 determines that the client device 2 is connected to the server 1 correctly.

In step S111, when the client device 2 is connected to the first server 1 correctly (hereinafter the client device 2 is referred to as “the connected client device 2”), the obtaining module 102 obtains an authorization level of the connected client device 2 from the second server 3. The obtaining module 102 queries the authorization level of the connected client device 2 from the authorization database 30 according to the account name of the connected client device 2.

In step S112, the transmission module 104 searches for available digital data to be browsed corresponding to the obtained authorization level of the connected client device 2, and transmits parameters of the available digital data to the connected client device 2. The parameters of the available digital data is displayed on the display screen 20 of the connected client device 2.

In step S113, the receiving module 106 receives a process command for processing specified digital data from the connected client device 2. The specified digital data is selected from the available digital data. The processing command is to purchase or to download the specified digital data.

In step S114, the determination module 108 determines whether the connected client device 2 is authorized to process the specified digital data according to the obtained authorization level, when the processing command is received from the connected client device 2. If the connected client device 2 is authorized to process the specified digital data, step S116 is implemented. If the connected client device 2 is not authorized to process the specified digital data, step S115 is implemented.

In one embodiment, if the processing command of purchasing the specified digital data is received, the determination module 108 determines that the connected client device 2 is authorized to purchase the specified digital data, when the obtained authorization level indicates that the connected client device 2 is authorized to purchase the specified digital data and the first server 1 receives a prompt of a successful trade. The determination module 108 further determines that the connected client device 2 is not authorized to purchase the specified digital data, when the obtained authorization level indicates that the connected client device 2 is not authorized to purchase the specified digital data, or when the obtained authorization level indicates that the connected client device 2 is authorized to purchase the specified digital data, but the first server 1 has not received the prompt of a successful trade within a preset time duration or the first server 1 receives a prompt of a failure trade.

In step S115, the prompt module 110 transmits a prompt of a wrong processing authorization to the connected client device 2, and step S112 is repeated. The prompt module 110 may transmit a message of “wrong processing authorization” to be displayed on the display screen 20 of the connected client device 2.

In step S116, the storing module 112 transmits the specified digital data to the connected client device 2 for storing the specified digital data in the storage system 22 of the connected client device 2.

FIG. 4 is a flowchart of one embodiment of a digital data uploading method. Depending on the embodiment, additional steps may be added, others removed, and the ordering of the steps may be changed.

In step S120, when one client device 2 is connected to the first server 1 by transmitting an account name and a password of the client device 2 to the first server 1 through the editing interface, the validation module 100 validates whether the client device 2 is connected correctly. The validation module 100 compares the account name and the password received from the client device 2 with the registration information stored in the content database 110.

In step S121, when the client device 2 is connected to the first server 1 correctly, the obtaining module 102 obtains the authorization level of the connected client device 2 from the second server 3. The obtaining module 102 queries the authorization level of the connected client device 2 from the authorization database 30 according to the account name of the connected client device 2.

In step S122, the receiving module 106 receives an upload command of digital data selected from the connected client device 2. The connected client device 2 may select a preset option of the upload command to execute an upload operation. In one embodiment, the connected client device 2 can edit the uploaded digital data stored in the storage system 22.

In step S123, the determination module 108 determines whether the connected client device 2 has authorization to upload the digital data according to the obtained authorization level, when the uploading command is received from the connected client device 2. If the obtained authorization level indicates that the connected client device 2 is authorized to upload the digital data, step S125 is implemented. If the obtained authorization level indicates that the connected client device 2 is not authorized to purchase the specified digital data, step S124 is implemented.

In step S124, the prompt module 110 transmits a prompt of a wrong uploading authorization to the connected client device 2, and the procedure ends. The prompt module 110 may transmit a message of “wrong uploading authorization” to be displayed on the display screen 20 of the connected client device 2.

In step S125, the storing module 112 receives uploaded digital data from the connected client device 23 and stores the uploaded digital data into the first server 1 according to a predetermined format.

In one embodiment, in order to ensure safety of transmission of the digital data, the first server 1 may adopt a predetermined encoding method to encrypt the transmitted digital data. The client device 2 may use a decoding method corresponding to the encoding method to obtain the transmitted digital data.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A digital data processing method being executed by a processor of a server, the server in communication with one or more client devices through a network, the method comprising:
obtaining an authorization level of a connected client device which is connected to the server;
searching for available digital data to be browsed corresponding to the obtained authorization level of the connected client device, and transmitting parameters of the available digital data to a display screen of the connected client device;
determining whether the connected client device is authorized to process specified digital data selected from the available digital data according to the obtained authorization level, when a processing command is received from the connected client device;
transmitting the specified digital data to the connected client device when the connected client device is authorized to process the specified digital data, or transmitting a prompt of a wrong processing authorization to the connected client device when the connected client device is not authorized to process the specified digital data.

2. The method of claim 1, wherein the processing command is to purchase or to download the specified digital data.

3. The method of claim 2, when a processing command of purchasing the specified digital data is received, the method further comprises:
determining that the connected client device is authorized to purchase the specified digital data when the obtained authorization level indicates that the connected client device is authorized to purchase the specified digital data and the server receives a prompt of a successful trade; or
determining that the connected client device is not authorized to purchase the specified digital data when the obtained authorization level indicates that the connected client device is not authorized to purchase the specified digital data, or when the connected client device is authorized to purchase the specified digital data, but the server has not received the prompt of a successful trade within a preset time duration or the server receives a prompt of a failure trade.

4. The method of claim 1, further comprising:
determining whether the connected client device is authorized to upload digital data from the connected client device according to the obtained authorization level, when an uploading command is received from the connected client device;
receiving uploaded digital data from the connected client device and storing the uploaded digital data into the server according to a predetermined format, when the connected client device is authorized to upload the digital data; or
transmitting a prompt of a wrong uploading authorization to the connected client device when the connected client device is not authorized to upload the digital data.

5. The method of claim 1, wherein the authorization level of the connected client device is obtained from an authorization database, and the authorization database stores data of different authorization levels corresponding to account numbers of different client devices, and stores data of available operations on the digital data corresponding to each of the authorization levels.

6. The method of claim 1, wherein the server comprises a database for storing digital data and the parameters of the digital data comprising a name, a miniature, a price, and a brief of each of the digital data, each of the digital data having one or more authorization levels which are available to be browsed.

7. A server in communication with one or more client devices, the server comprising:
at least one processor; and
a storage device storing one or more programs, when executed by the at least one processor, cause the at least one processor to perform operations of:
obtaining an authorization level of a connected client device which is connected to the server;
searching for available digital data to be browsed corresponding to the obtained authorization level of the connected client device, and transmitting parameters of the available digital data to a display screen of the connected client device;
determining whether the connected client device has authorization to process specified digital data selected from the available digital data according to the obtained authorization level, when a processing command is received from the connected client device;
transmitting the specified digital data to the connected client device when the connected client device is authorized to process the specified digital data, or transmitting a prompt of a wrong processing authorization to the connected client device when the connected client device is not authorized to process the specified digital data.

8. The server of claim 7, wherein the processing command is to purchase or to download the specified digital data.

9. The server of claim 8, when a processing command of purchasing the specified digital data is received, the operations further comprise:
determining that the connected client device is authorized to purchase the specified digital data when the obtained authorization level indicates that the connected client device is authorized to purchase the specified digital data and the server receives a prompt of a successful trade; or
determining that the connected client device is not authorized to purchase the specified digital data when the obtained authorization level indicates that the connected client device is not authorized to purchase the specified digital data, or when the connected client device is authorized to purchase the specified digital data, but the server has not received the prompt of a successful trade within a preset time duration or the server receives a prompt of a failure trade.

10. The server of claim 7, further comprising:
determining whether the connected client device is authorized to upload digital data from the connected client device according to the obtained authorization level, when an uploading command is received from the connected client device;
receiving uploaded digital data from the connected client device and storing the uploaded digital data into the server according to a predetermined format, when the connected client device is authorized to upload the digital data; or
transmitting a prompt of a wrong uploading authorization to the connected client device when the connected client device is not authorized to upload the digital data.

11. The server of claim 7, wherein the authorization level of the connected client device is obtained from an authorization database, and the authorization database stores data of different authorization levels corresponding to account numbers of different client devices, and stores data of available operations on the digital data corresponding to each of the authorization levels.

12. The server of claim 7, wherein the server comprises a database for storing digital data and the parameters of the digital data comprising a name, a miniature, a price, and a brief of each of the digital data, each of the digital data having one or more authorization levels which are available to be browsed.

13. A non-transitory computer-readable medium having stored thereon instructions that, when executed by at least one processor of a server, the server in communication with one or more client devices, cause the at least one processor to perform operations of:
obtaining an authorization level of a connected client device which is connected to the server;
searching for available digital data to be browsed corresponding to the obtained authorization level of the connected client device, and transmitting parameters of the available digital data to a display screen of the connected client device;
determining whether the connected client device has authorization to process specified digital data selected from the available digital data according to the obtained authorization level, when a processing command is received from the connected client device;
transmitting the specified digital data to the connected client device when the connected client device is authorized to process the specified digital data, or transmitting a prompt of a wrong processing authorization to the connected client device when the connected client device is not authorized to process the specified digital data.

14. The medium of claim 13, wherein the processing command is to purchase or to download the specified digital data.

15. The medium of claim 14, when a processing command of purchasing the specified digital data is received, the operations further comprise:
determining that the connected client device is authorized to purchase the specified digital data when the obtained authorization level indicates that the connected client device is authorized to purchase the specified digital data and the server receives a prompt of a successful trade; or
determining that the connected client device is not authorized to purchase the specified digital data when the obtained authorization level indicates that the connected client device is not authorized to purchase the specified digital data, or when the connected client device is authorized to purchase the specified digital data, but the server has not received the prompt of a successful trade within a preset time duration or the server receives a prompt of a failure trade.

16. The medium of claim 13, further comprising:
determining whether the connected client device is authorized to upload digital data from the connected client device according to the obtained authorization level, when an uploading command is received from the connected client device;
receiving uploaded digital data from the connected client device and storing the uploaded digital data into the server according to a predetermined format, when the connected client device is authorized to upload the digital data; or
transmitting a prompt of a wrong uploading authorization to the connected client device when the connected client device is not authorized to upload the digital data.

17. The medium of claim 13, wherein the authorization level of the connected client device is obtained from an authorization database, and the authorization database stores different authorization levels corresponding to account numbers of different client devices, and stores available operations to the digital data corresponding to each of the authorization levels.

18. The medium of claim 13, wherein the authorization level of the connected client device is obtained from an authorization database, and the authorization database stores data of different authorization levels corresponding to account numbers of different client devices, and stores data of available operations on the digital data corresponding to each of the authorization levels.
